(19) United States
(12) Patent Application Publication
(10) Pub. No.: US 2010/0059274 A1
(43) Pub. Date: Mar. 11, 2010

(54) ELECTRODE SYSTEM AND LEAD ASSEMBLY FOR PHYSIOLOGICAL MONITORING

(75) Inventors: John Richard Ives, Manotick (CA); Susan Elizabeth Phelan, Manotick (CA)

Correspondence Address: GALLOP, JOHNSON & NEUMAN, L.C., 101 S. HANLEY, SUITE 1600, ST. LOUIS, MO, 63105, US

(73) Assignee: IVES EEG SOLUTIONS, INC., MANOTICK, ONTARIO (CA)

(21) Appl. No.: 12/513,087

(22) PCT Filed: Nov. 30, 2007
(86) PCT No.: PCT/CA07/02129

§ 371 Date: Apr. 30, 2009

Related U.S. Application Data
(60) Provisional application No. 60/861,741, filed on Nov. 30, 2006.

(51) Int. Cl. H01B 7/00

(52) U.S. Cl. 174/71 R

(57) ABSTRACT

The present invention provides an electrode system and lead assembly for linking one or more electrodes to a physiological monitoring device. In general, the lead assembly comprises one or more lead sets and one or more lead links. The lead set generally comprises one or more leads each coupled at one end to a set connector, and at an other end, each coupled or adapted to be coupled to a respective electrode of the electrode system. The lead link generally comprises a link connector and one or more link leads operatively coupled thereto, each set lead being operatively coupleable to a corresponding link lead via direct or indirect operative coupling of the set connector and the link connector. Each link lead is further adapted to be coupled to one or more physiological monitoring devices, either by direct connection via a common or distinct connector(s) integral to the lead link, or by indirect connection via one or more additional connectors. The invention also provides for a lead set for linking multiple electrodes to a physiological monitoring device via an intermediary link, the lead set comprising multiple leads each adapted for operative coupling to a respective one the multiple electrodes and a connector adapted for connection to the intermediary link wherein each of said leads is operatively coupled to said connector and operatively coupleable to the monitoring device via connection of said connector to the intermediary link.

This is a national stage application that claims priority from PCT application no. PCT/CA2007/002129, filed on Nov. 30, 2007, which claims priority from U.S. provisional application Ser. No. 60/861,741, filed on Nov. 30, 2006.

### FIELD OF THE INVENTION

The present invention relates generally to the field of physiological monitoring, and more particularly, to an electrode system and lead assembly therefor.

### BACKGROUND

Electrically active cells in the body produce a wide variety of voltage signals that are useful to detect physiological conditions in patients. The detection is achieved ‘using biopotential electrodes that act as transducers by transforming the electric potentials at a particular biological tissue into an electric voltage that can be measured by conventional measurement and recording devices such as, an electrocardiograph (ECG) which monitors heart activity, an electroencephalograph (EEG) which monitors electrical activity in the brain, electrical impedance tomograph (EIT) which monitors changes in lung volume, electromyograph (EMG) which monitors other muscle activity in the body, and an electro-oculograph (EOG) which monitors the electrical activity of the muscles that control eye movement.

Many types of biopotential electrodes have been developed over the years, such as metal plate electrodes, suction electrodes, floating electrodes, flexible electrodes, needle electrodes and more recently, dry electrodes, spiked electrodes and subdermal wire electrodes. The choice of biopotential electrodes is selected based on many factors including the particular biological tissue being monitored, the patient's status, the ease of usage and the cost.

In order to measure a patient's biopotentials, a trained electrophysiologist would typically prepare the skin and individually attach electrodes in predetermined areas that are well known in the art for monitoring a particular tissue. The proper placement of the electrodes is essential to the biopotentials beings monitored and the number of electrodes used depends on the tissue being monitored and the information required. Many medical diagnostic apparatus require up to ten single point contact biopotential electrodes, and some advanced analysis may require 30 to 100 electrodes. Accurately placing and securing a large number of electrodes can be a very tedious and labour intensive process that involves measuring the location of the precise site for attaching each electrode, marking the attachment site, preparing the attachment site, attaching the electrode to the site and attaching each electrode lead to the physiological monitoring device. For example, in the case of conventional scalp electrodes, a skilled technician would remove or displace the hair, clean the scalp, mark the locations on the scalp, attach the electrode using tape or collodion, apply a conductive agent such as gel or solution between the electrode and the scalp. The procedure can take up upwards of 45 minutes for attaching approximately 20 electrodes.

Patients in Intensive Care Units, OR's and other long term units, often need to be monitored continuously over long periods of time to assess the effectiveness of therapy, determine the depth of sedation and other physiological changes in tissue function that could indicate the development of life-threatening or unstable conditions. Given, however, that these patients require frequent imaging or to be transported to various areas of the facility, they must be disconnected from the physiological monitoring devices. This is typically accomplished by removing the electrodes on the patient or by disconnecting the leads from the physiological monitoring device.

A problem associated with removing the electrodes on the patient is that the assistance of a skilled technician may be required to remove and re-apply the electrodes. A skilled technician may not always be readily available which may result in loss of time in biopotential recording or scalp abrasions due to the removal of the electrodes by a caregiver. A further problem is that it is extremely difficult to affix the electrodes at the same location on the patient which is recommended to provide a continuing profile of a patient's biopotentials.

On the other hand, disconnecting the leads at the monitoring device may not require a skilled technician, however, the patient is left with a plurality of lengthy electrode leads dangling from his body. The lengthy leads, which often measure up to 10 feet, can easily become tangled with each other preventing a caregiver from attending to the patient. Long leads may also limit the patient's freedom of movement or become tangled with other medical devices.

There is also an advantage to obtaining simultaneous information from various physiological monitoring devices. For example, a temporal correlation could be obtained by combining EEG and MRI measurements. One of the problems with this combination is that the radiofrequency fields created during an MRI exam can also heat the electrodes and the electrode leads, thereby possibly burning or reddening the underlying skin.

Different systems have been devised to provide quick connection electrode devices, such as specialized cap or strapped-on headgear with mounted electrodes for brain monitoring. The electrodes are mounted to protrude from the headgear in order to contact the scalp of the patient. While these types of devices assist a skilled technician in reducing the time for placing and attaching the electrodes, some of the drawbacks associated with these devices include poor surface contact with a patient's skin, maintaining the correct placement of all electrodes simultaneously, irritation from the pressure points due to uneven tensions in the electrode placement, interference of the device with other medical procedures, the high cost of these fairly complex devices and the need to clean/sterilize the devices before reuse can compromise some of the initial properties of the headgear.

Accordingly, there is a need for a new electrode system and lead assembly for physiological monitoring that overcomes some of the drawbacks of known technologies.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the invention is to provide a lead assembly for linking one or more electrodes to a physiological monitoring device, the lead assembly comprising: a lead set comprising a set connector and one or more set leads operatively coupled thereto, each one of which adapted for operative coupling to a respective one of the one or more electrodes; and a lead link comprising a link connector and one or more link leads operatively coupled thereto, each one of which adapted for operative coupling to the monitoring device; wherein each one of said one or more set leads corresponds to a respective one of said one or more link leads and is operatively coupleable thereto via operative coupling of said link connector and said set connector.

In accordance with another aspect of the invention, there is provided an electrode system for use with a physiological monitoring device, the system comprising: one or more electrodes; a lead set comprising a set connector and one or more set leads operatively coupled thereto, each one of which operatively coupled to a respective one of said one or more electrodes; a lead link comprising a link connector and one or more link leads operatively coupled thereto, each one of which adapted for operative coupling to the monitoring device; wherein each one of said one or more set leads corresponds to a respective one of said one or more link leads and is operatively coupleable thereto via operative coupling of said link connector and said set connector.

In accordance with another aspect of the invention, there is provided a lead set for linking multiple electrodes to a physiological monitoring device via an intermediary link, the lead set comprising multiple leads each adapted for operative coupling to a respective one the multiple electrodes and a connector adapted for connection to the intermediary link wherein each of said leads is operatively coupled to said connector and operatively coupleable to the monitoring device via connection of said connector to the intermediary link.

### BRIEF DESCRIPTION OF THE FIGURES

FIG. 1 is a schematic diagram of an electrode system, in accordance with an embodiment of the invention.

FIG. 2 is a schematic diagram of various elements of a lead assembly, in accordance with an embodiment of the invention.

FIGS. 3A and 3B are schematic diagrams of an electrode coupling, in accordance with the embodiment of FIG. 2.

FIG. 4 is a schematic diagram of an electrode system, in accordance with another embodiment of the invention.

FIG. 5 is a schematic diagram of a lead set of an electrode system, in accordance with another embodiment of the invention.

FIG. 6 is a schematic diagram of a lead link for use with the lead set of FIG. 5.

FIG. 7 is a schematic top down view of an electrode set when disposed on a patient's head, in accordance with an embodiment of the invention.

FIG. 8 is a schematic top down view of a lead assembly of FIGS. 5 and 6, when disposed on a patient's head.

FIG. 9 is a schematic front side view of an electrode set when disposed on a patient's head, in accordance with another embodiment of the invention.

FIG. 10 is a schematic top down view of an electrode system, and lead assembly therefor, when disposed on a patient's head, in accordance with another embodiment of the invention.

FIG. 11 is a schematic diagram of an electrode system, and lead assembly therefor, when disposed on a patient's body, in accordance with an embodiment of the invention.

FIG. 12, is schematic diagram of an electrode system, and lead assembly therefor, when disposed on a patient's chest, in accordance with an embodiment of the invention.

FIG. 13, is schematic diagram of an electrode system, and lead assembly therefor, when disposed on a patient's leg, in accordance with an embodiment of the invention.

FIG. 14, is schematic diagram of an electrode system, and lead assembly therefor, when disposed on a patient's arm, in accordance with an embodiment of the invention.

FIG. 15 is schematic diagram of an electrode system, and lead assembly therefor, for use with a portable recording device when disposed on a patient's chest, in accordance with an embodiment of the invention.

### DETAILED DESCRIPTION OF THE INVENTION

### Definitions

The term “patient” is used herein to define a subject that may benefit from physiological monitoring. The subject may include a human subject such as a hospital patient, a resident of a retirement or nursing home, a home care patient, and the like, or again an animal in a veterinary clinic or hospital, receiving care at a home or farm, and the like. Furthermore, the patient may be subject to the physiological monitoring in different conditions (e.g. healthy patient, comatose patient, sick patient, patient at risk, etc), and under different circumstances (e.g. monitoring, diagnostics, analysis, etc.).

As used herein, the term “physiological monitoring device” may include, but is not limited to, portable and/or stationary devices useful in monitoring, measuring, analysing, communicating and/or other such functions related to biopotential data and/or signals acquired from a patient, including without limitation electrocardiography (ECG), electroencephalography (EEG), electrical impedance tomography (EIT), electromyography (EMG), and electro-oculography (EOG), for example.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides an electrode system and lead assembly for linking one or more electrodes to a physiological monitoring device. In general, the lead assembly comprises one or more lead sets and one or more lead links. The lead set generally comprises one or more leads each coupled at one end to a set connector, and at another end, each coupled or adapted to be coupled to a respective electrode of the electrode system. The lead link generally comprises a link connector and one or more link leads operatively coupled thereto, each set lead being operatively coupleable to a corresponding link lead via direct or indirect operative coupling of the set connector and the link connector. Each link lead is further adapted to be coupled to one or more physiological monitoring devices, either by direct connection via a common or distinct connector(s) integral to the lead link, or by indirect connection via one or more additional connectors.

According to some embodiments of the electrode system, and lead assembly thereof, the lead set may be quickly and conveniently disconnected from the lead link, and therefor from a monitoring device to which the lead link is connected, without removing the electrodes from the patient's body. In some embodiments, this configuration may prevent or reduce having lengthy electrode leads dangling from the patient's body, for instance as the patient is moved from one monitoring station to another, for example. This may thus facilitate patient transfer and avoid or at least reduce the likelihood of having leads get tangled, for example, with other medical devices. It can also, in some embodiments, facilitate replacement of electrodes in the lead assembly. For example, when using one time use or disposable electrodes, which may be used so to avoid compromising the initial properties of the electrodes, using an electrode system and assembly, as described herein, comprising a separable lead set and link, may facilitate electrode replacement and maintenance. These and other advantages will become more apparent to a person skilled in the art upon further reading of the description.

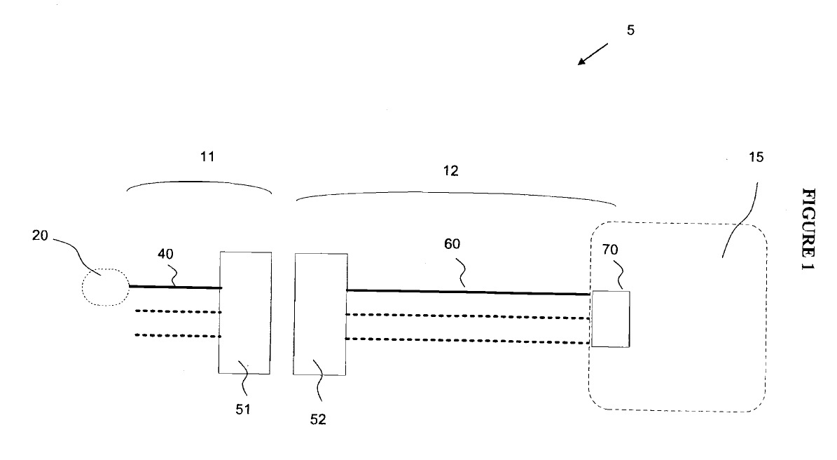

With reference to FIG. 1, the various components of an electrode system, generally referred to using the numeral 5 and in accordance with an embodiment of the invention, will now be described. In general, the electrode system 5, and lead assembly thereof, comprises a lead set 11 and a lead link 12.

The lead set 11 generally comprises a set connector 51 and one or more set leads 40 operatively coupled thereto. Each set lead may further optionally comprise an electrode connector (not shown) configured for operative coupling to an electrode, or a given type of electrode, or again be adapted for operative coupling to an electrode via a distinct connector. Examples of such electrode couplings will be provided in the following examples. The lead link 12 generally comprises a link connector 52 and one or more link leads 60 operatively coupled thereto, each set lead 40 corresponding to a respective link lead 60 such that, when the set connector 51 and the link connector 52 are operatively coupled, either directly or indirectly via one or more intermediary devices (not shown), an electrical contact is provided therebetween for conveying an electrode signal therethrough. Each link lead 60 may further optionally comprise one or more integral or selectable physiological monitoring device connectors 70 for direct or indirect operative coupling to one or more respective monitoring devices 15, or again may be coupleable thereto via one or more common connectors adapted to transfer signals from two or more link leads 60 to a same device 15. It will be appreciated by the person of ordinary skill in the art that various types of electrodes, leads and connectors, examples of which are provided herein below, may be considered herein to provide similar results, and as such, are not considered to depart from the general scope and nature of the present disclosure.

In addition, it will be appreciated that although the following detailed description provides examples mostly directed to the use of an electrode system and assembly for electroencephalograph (EEG) monitoring, the embodiments of the invention described herein may find applications in a number of other types of physiological monitoring, as defined above. EEG monitoring is provided herein by way of example only and therefore, the various embodiments of the invention are not intended to be considered limited as such.

### Electrode(s)

The electrode assembly may be configured for use with different types of electrodes, each generally used to detect electric potentials in biological tissues. The choice of electrodes and the number of electrodes to be used with the leas assembly and electrode system may be determined, for example, by a patient's status, the planned recording time, the circumstances and environment they are being monitored in, and/or the imaging modalities planned. Each type of electrode may have unique recording properties, application methods and/or medial imaging compatibility properties. For example, traditional biopotential electrodes are made of magnetic materials making them incompatible with magnetic resonance imaging (MRI), computed tomography (CT) as well as Angiogram and X-Ray devices. In one embodiment, which will be described in greater detail below, the electrodes used with the lead assembly and the electrode system may be compatible with one or more of magnetic resonance imaging (MRI), computed tomography (CT), Angiogram and X-Ray devices, for example.

In one embodiment, the electrodes used are gold disc cup electrodes (for example, Grass Gold Cup manufactured by Grass/Astromed). These are a non-invasive type of electrode which is applied on the skin of a patient. They are MRI compatible since it is made of gold, a non-magnetic metal. They are not, however, CT, X-Ray or Angiogram compatible, and thus must be removed and replaced for these imaging modalities. This type of electrode may be susceptible to physiological artefacts caused by movement of the body. The gold disc cup electrodes must be placed by a skilled technologist after careful skin preparation. Conductive jelly must also be applied to these electrodes every 12 to 24 hours to re-establish low impedance and signal integrity. The electrodes can be further secured to the patient using a wrap, tape or collodion which solidifies as it dries and retains the wire electrode in the desired position.

In another embodiment, the electrodes used are conductive plastic electrodes cup coated with conductive silver-epoxy. The plastic electrodes used are available from, for example, Plastic One and The Electrode Store. Conductive plastic electrodes do not generally have very high quality recording properties, however, coating the inner dome of the plastic electrodes with a conductive silver-epoxy, significantly improves the recording quality, creating a high quality silver-silver/chloride (Ag—Ag/Cl) electrode. The quality obtained is comparable to that of a standard biopotential electrode. This type of electrode is also a non-invasive type which is placed on the skin of a patient and is MRI, CT, X-Ray and Angiogram compatible. The non-metallic nature of the electrode material also makes this type of electrode less susceptible to physiological artefacts caused by movement of the body. As was the case with the gold disc cup electrodes, the conductive plastic electrodes cup coated with conductive silver-epoxy must be placed by a skilled technologist after careful skin preparation and conductive jelly must be applied to the electrodes every 12 to 24 hours to re-establish low impedance and signal integrity. The electrodes can be further secured to the patient using a wrap, tape or collodion which solidifies as it dries and retains the wire electrode in the desired position.

In another embodiment, the electrodes used are subdermal wire electrodes (SWE) consisting of fine silver-silver/chloride (Ag—Ag/Cl) wire electrodes. In one embodiment, the subdermal wire electrode is a Teflon® insulated multi-stranded pure silver wire with an exposed tip which is coated in Ag—Ag/Cl by electrolysis in a saline bath to create a low impedance, stable biopotential electrode. The fine wire is placed subdermally by carrying it with a hypodermic needle. Once, the wire electrode is in place, the needle is removed the wire electrode can remain in the subdermal space for many days or weeks. The electrodes can be further secured to the patient using a wrap, tape or collodion which solidifies as it dries and retains the wire electrode in the desired position. This type of electrode is compatible with all imaging modalities (MRI, CT, X-Ray and Angiogram) and does not require careful skin preparation. It also does not require conductive jelly to re-establish low impedance and signal integrity. An advantage of the subdermal wire electrodes is that it can record biopotential signals for weeks without any further adjustment unless an electrode is dislodged or inadvertently disconnected. Given that the subdermal wire electrode is placed subdermally by carrying it with a hypodermic needle, a skilled technician is not required to apply the subdermal wire electrodes. The electrodes can be applied to a patient by any caregiver who is trained in working with needles.

One of the factors that may be used to determine the choice of electrodes to be used with the electrode assembly is the status of the patient. Given that the subdermal wire electrode is a semi-invasive procedure requiring a needle to position the wire electrode subdermally, it may be somewhat painful for non-comatose patients requiring a large number of electrodes. The subdermal electrode is painless once implanted, therefore, if the subdermal wire electrode is implanted in a comatose patient who regains consciousness, the patient would not be disturbed by the wire electrode. For non-comatose patients requiring a large number of electrodes, disc electrodes may be more suitable. The choice between conductive plastic electrodes cup coated with conductive silver-epoxy and gold disc cup electrodes depends mostly on the clinical context. For example, conductive plastic electrodes cup coated with conductive silver-epoxy may be better suited for patients with intracranial haemorrhage, brain oedema or another mass-occupying lesion that could require urgent CT imaging. Gold disc cup electrodes may be preferred for patients with other pathologies requiring MR scans given the gold disc cup electrodes' excellent signal properties and resistance for successive monitoring. For agitated patients, a head bandage overlying the glued electrodes allows for additional protection of the electrodes from the patients hands and will slow the drying if the jelly if a disc electrode is used.

In on embodiment, the electrodes are covered by bandage to avoid potential artefacts.

It will be appreciated by the person skilled in the art that other types of electrodes, and combinations thereof, may be considered herein and selected based on a number of considerations known in the art, without departing from the general scope and nature of the present disclosure.

### Lead Assembly

The electrode system generally comprises a lead assembly comprised of a lead set having one or more set leads operatively coupled to a set connector, and a lead link having one or more corresponding link leads operatively coupled to a link connector. In general, the one or more leads of the system (i.e. the one or more set leads and corresponding link leads) provide, via operative coupling of the set and link connectors, and optionally via other such connectors as electrode and device connectors, an electrical connection between the system's one or more electrodes and a physiological monitoring device. The leads generally comprise a carrier or conduit for one or more electrical conductors useful in electrically coupling one or more electrodes to a detection, monitoring or analyzing device. The electrode lead may be constructed of any non-ferromagnetic conductive material, such as Silver, Tin, Gold, Carbon, Platinum, Iridium, Silver/Silver Chloride, Conductive Plastic, Carbonized Plastic and Carbon Fibers. The conductive material is then insulated with a flexible non-conductive material, such as a plastic layer. Each electrode in the electrode system generally has its own lead, however, in one embodiment, two or more leads may be branched from a single electrode for simultaneous use with different devices. In one embodiment the electrode leads are flexible multifilament silver tinsel leads.

In one embodiment, the lead assembly, lead set, lead link, and/or various components thereof, comprise one time use disposable devices.

In one embodiment, the voltage differential between the electrodes capturing a physiological signal and a reference electrode can be extremely small, for example on the order of millivolts or microvolts. In order to amplify a detected physiological signal in such embodiments, amplifying and multiplexing elements can be used. The amplification has the potential to reduce artefact and simplify trouble-shooting. The amplifier may, for example, interface with the electrodes, convert the physiological electrical signals into digital data, and transmit that information to the physiological monitoring device. In one embodiment, one or more amplifier and/or multiplexer elements are coupled to the set connector or link connector to amplify the signal close to its source. In another embodiment, a small surface-mounted instrumentation amplifier is coupled with an analog multiplexer and integrated directly into the lead set or electrode set amplifying and multiplexing up to 128-channels of signal in close proximity to the location of the electrodes on the body.

In one embodiment, the lead assembly or electrode system is coupled to a portable recording device coupled to the patient.

### Set Lead(s)

As described above, each set lead is operatively coupled to a set connector, and coupled, or adapted to be coupled, to a respective electrode. In one embodiment, one end of each set lead comprises an electrode connector (or other such coupling means) comprising a male pin contact which is crimped or soldered to the end of the lead, so as to be electrically coupled thereto. The electrodes used with this assembly would have a female socket contact adapted to receive the male pin contact on the end of the set lead. This would provide an electrical connection between the two connecting elements. The use of such coupling means to couple an electrode and a set lead may allow a skilled technician to quickly replace a defective electrode or change the electrodes of an electrode assembly, for example.

In another embodiment, a disc cup electrode is electrically coupled to a set lead by soldering the end of the bare set lead to the electrode.

In yet another embodiment, a disc cup electrode is electrically coupled to a set lead by drilling a small hole in the dome of the electrode, inserting a few millimetres of bared lead thru the hole and soldering the lead strand to the inner dome wall of the electrode.

In general, the opposite end of each set lead is coupled to a lead connector, which is adapted to receive and couple a number of set leads for operative coupling, via a corresponding link connector, to corresponding link leads. For example, in one embodiment, a ten pin mass connector is used to couple eight active leads, a ground lead, and a reference lead. Other such examples will be provided below.

The lead(s) can be can be customized to facilitate the placement of electrodes by a technician using colour, various lengths, labels, pictographic icons, and other such techniques. For example, in one embodiment, the set leads and link leads are color coded for specific body areas or may contain an outline and/or colour marking(s) to simplify the attachment of electrodes for the monitoring of a particular tissue.

In another embodiment, the set leads are labelled to help a skilled technician attach electrodes in predetermined areas that are well known in the art for monitoring a particular tissue.

In another embodiment, the set leads bear a pictographic icon which identifies where the associate electrode is to be placed on the body.

In another embodiment, the set leads are of predetermined lengths to help a skilled technician attach electrodes in predetermined areas that are well known in the art for monitoring a particular tissue. For instance, in one embodiment, in one embodiment, each set lead may be of a predetermined length selected to substantially correspond with an average dimensional configuration of electrodes selected for a given patient body part, or type of tissue to be monitored. In such embodiments, placement of the electrodes on the patient's body may be facilitated as the predetermined lead lengths may provide a first indication as to the relative placement of these electrodes for appropriate monitoring. For example, different set leads may have different lengths selected to substantially correspond with lengths needed to reach predetermined placement locations on an adult head, for example, while keeping the set leads relatively short and taut. Such a configuration could prevent the set leads from becoming tangled or snagging on other instruments, and could also prevent coiling of the leads, which can cause heating and burning in the MRI environment, for example. Other examples wherein predetermined set lead lengths may be applicable should be apparent to the person of skill in the art, and are therefore not considered to depart from the general scope and nature of the present disclosure.

In another embodiment, the set leads are of specific lengths, labelled and/or coloured to help a skilled technician attach electrodes in predetermined areas that are well known in the art for monitoring a particular tissue.

In an embodiment where set lead lengths are selected for the average adult head, the lengths may be selected, for example, such that electrode placement is consistent with the International 10-20 System.

In another embodiment, a lead set or an electrode set for a patient's head comprises a plurality of set leads of predetermined lengths to attach electrodes to the scalp in positions Fp1, Fp2, T3, T4 C3, C4; O1, O2, a ground (GND) and a reference (REF) that are well known in the art for monitoring brain activity.

In another embodiment, a lead set or an electrode set for a patient's head comprises a plurality of set leads of predetermined lengths to attach electrodes to the scalp in positions Fp1, F3, C3, P3, O1, F7, T3, T5, ground (GND), FP2, F4, C4, P4, O2, F8, T4, T6, a reference (REF), FZ, CZ, PZ, T1, T2, A1, A2, VOG and HOG that are well known in the art for monitoring brain activity.

In another embodiment, a lead set or an electrode set for a patient's head comprises a plurality of set leads of predetermined lengths to attach electrodes to specific locations of the scalp according to the International 10-20 System specification and are labelled using location codes (letters and numbers) of the International 10-20 System in order to facilitate the location of a specific areas on the scalp by a caregiver or skilled technician.

In another embodiment, a lead set or an electrode set for a patient's head comprises a plurality of set leads of predetermined lengths to attach electrodes to the scalp in positions Fp1, Fp2, T3, T4 C3, C4, O1, O2, a ground (GND) and a reference (REF) that are well known in the art for monitoring brain activity and are labelled using the same location codes in order to facilitate the placement of each electrode to a specific area on the scalp.

In another embodiment, a lead set or an electrode set for a patient's head comprises a plurality of set leads of predetermined lengths to attach electrodes to the scalp in positions Fp1, F3, C3, P3, O1, F7, T3, T5, ground (GND), FP2, F4, C4, P4, O2, F8, T4, T6, a reference (REF), FZ, CZ, PZ, T1, T2, Al, A2, VOG and HOG that are well known in the art for monitoring brain activity and are labelled using the same location codes in order to facilitate the placement of each electrode to a specific area on the scalp.

In another embodiment, the leads of the lead set for an adult patient's head range in length from about 10 to about 30 cm depending on their location on the head with respect to the vertex.

It will be appreciated by the person of ordinary skill in the art that various other types and combinations of set leads may be considered herein to provide similar effects, for instance in relation to the monitoring of a patient's head, other body parts, and/or various other tissues, without departing from the general scope and nature of the present disclosure. It will also be appreciated that while some of the set leads may be configured to provide one or more indicators or coding (e.g. length, colour, alpha-numeric code, etc.) as to their appropriate positioning relative to one another and/or relative to a particular body or tissue reference, others within a same or different set may not be so coded.

### Link Lead(s)

As described above, each link lead is operatively coupled to a link connector, and directly or indirectly coupleable, either via a common or distinct connection, to a monitoring device. Each set lead, described above, generally corresponds to a respective one of the link lead(s), which, when operatively coupled thereto via the set and link connectors, is adapted to continue the transfer of the biopotentials captured by the electrodes to the physiological monitoring device.

It is at times desirable to reduce the number of leads/connections between the patient and the physiological monitoring device since environments such as intensive care units, operating rooms and recovery rooms can often be cluttered with tubes and wires from various other medical devices. Accordingly, in some embodiments, the one or more link leads are interwoven creating a braid of leads providing flexibility of the link lead(s) while ensuring that they remain in close proximity of each other to eliminate or reduce possible artefacts. In another embodiment, the link lead(s) are additionally or alternatively housed within an outer sheathing or covering to protect the leads against damage, which may also serve to keep the group of link leads in a tighter group, thereby reducing clutter. It will be appreciated that other techniques may be considered to group at least some of the one or more link leads to provide similar effects.

### Connectors

The connectors contemplated herein are generally configured to provide a good electrical connection between the leads of the lead set and lead link, and optionally between each set lead and its respective electrode, and between the lead link and the monitoring device to be used. The set connector and link connector should also permit the fast and efficient connection and disconnection of these connectors enabling a caregiver to quickly disconnect the patient from the physiological monitoring device without the assistance of a skilled technician. A worker skilled in the art will appreciate that a wide variety of connector types and assemblies could be used in the present context to provide these results. For example, in one embodiment, the set and link connectors comprise standard safety DIN lead connectors. It will be appreciated that other types of connectors known in the art can be considered herein without departing from the general scope and nature of the present disclosure

In one embodiment, the connectors are marked to facilitate the mating of set and link connectors. Various connector mating techniques are known in the art, either based on for example shape, size, notch and groove alignment, colour and/or alpha-numeric coding and can be considered herein.

In on embodiment, the electrodes are covered by bandage and the set and/or link connector is kept away from the skull, or other body part, using an MRI compatible sponge to avoid potential artefacts.

The invention will now be described with reference to specific examples. It will be understood that the following examples are intended to describe embodiments of the invention and are not intended to limit the invention in any way.

### EXAMPLES

### Example 1

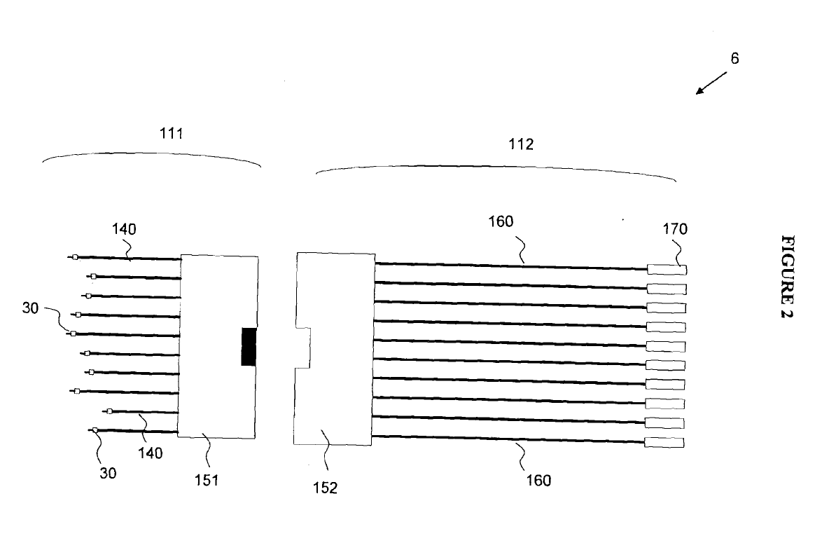

FIG. 2 illustrates a lead assembly 106 according to an embodiment of the invention. The lead assembly 106 comprises of a lead set 111 and a lead link 112. The lead assembly 106 generally comprises a plurality of set leads 140, electrode connectors, as in connectors 130, and a set connector 151. In this embodiment, the first end of each set lead 140 comprises an electrode connector 130. The opposite end of the set leads 140 is coupled to the set connector 151 which is adapted to receive and couple one or more leads 140. Each electrode connector 130 is adapted to be coupled to a respective electrode. The electrodes can be, for example, a subdermal wire electrode. The lead connector 151 is also configured to operatively couple with the link connector 152 of the lead link 112 described below.

The lead link 112 generally comprises of a link connector 152, a plurality of link leads 160 and a plurality of physiological monitoring device connectors 170. The link connector 152 is configured to receive the plurality of link leads 160; it is also configured to be operatively coupled to the set connector 151. One end of each link lead 160 is coupled to the link connector 152 and the opposite end is coupled to a physiological monitoring device connector 170. The connectors 170 are individual lead connectors which are adapted to connect and feed the voltage signals to a given device for recording, displaying and/or analysing the signals. The number of leads used in a lead assembly will depend primarily upon the tissue being monitored. FIG. 1, for example, illustrates a lead assembly for ten electrodes.

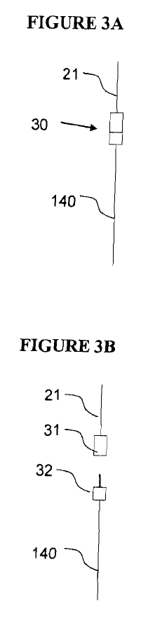

With reference to FIGS. 3A and 3B, in accordance with one embodiment of the invention, the electrode connector 130 comprises a male/female contact system for coupling a male pin contact 132 to a female socket contact 131. The male pin contact 132 is crimped or soldered to the first end of the lead set 140, so as to be electrically coupled thereto. A heat shrink tubing (not shown) can also be applied to protect the electrical connection. The female socket contact 131 is crimped or soldered or otherwise coupled to one end of the subdermal wire electrode 121. The female socket contact 131 is adapted to receive the male pin contact 132 providing an electrical connection between the two connecting elements.

### Example 2

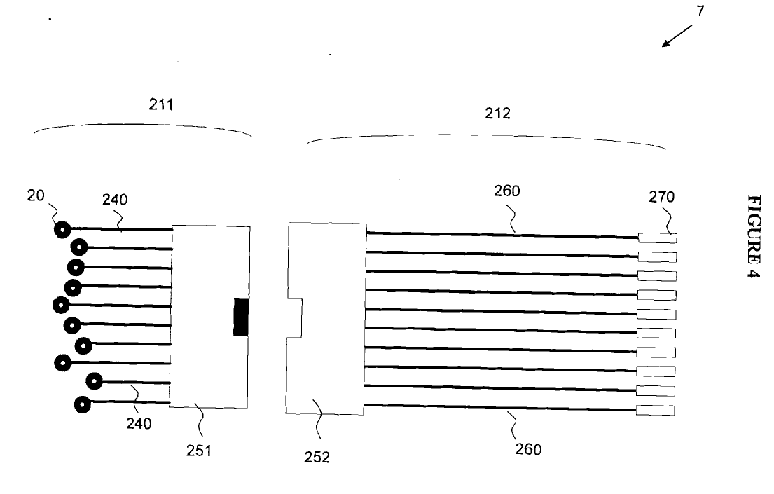

With reference to FIG. 4, and in accordance with another embodiment of the invention, there is provided an electrode system, generally referred to using the numeral 205 for physiological monitoring. The electrode system 205 comprises a lead set 211 and a lead link 212.

The lead set 211 is operatively coupled to a plurality of electrodes 220, and comprises a plurality of set leads 240, and a set connector 251. The electrodes as depicted in FIG. 4 are disc cup electrodes. A worker skilled in the art would readily be able to determine that a wide variety of biopotential electrodes may be used in the electrode system according to the invention. One end of each set lead 240 is electrically coupled to an electrode 220. A heat shrink tubing can also be applied at the connection site to protect the electrical connection. The opposite end of the set lead 240 is coupled to the set connector 251 adapted to receive and couple the plurality of set leads 240. The set connector 251 is also configured to be operatively coupled with the link connector 252 of the lead link 212.

The lead link 212 is comprised of a link connector 252, a plurality of link leads 260 and a plurality of physiological monitoring device connectors 270. The link connector 252 is configured to receive the plurality of link leads 260. It is also configured to be operatively coupled to the set connector 251. One end of each link lead 260 is coupled to the link connector 252 and the opposite end is coupled to a physiological monitoring device connector 270. The connectors 270 are individual lead connectors which are adapted to connect and feed the voltage signals to a given device for recording, displaying and/or analysing the signals. It will be appreciated that a common connector may also be used to provide a similar result.

### Example 3

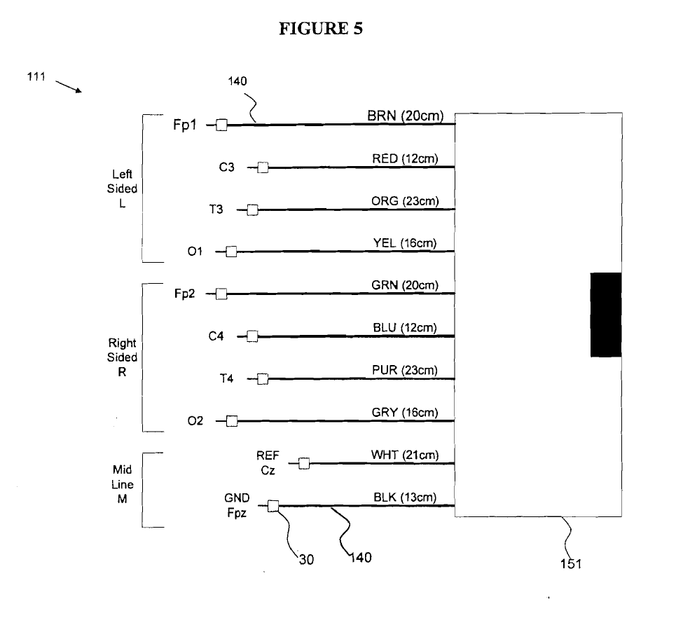

FIG. 5 illustrates a lead set 111 to be placed on a patient's head for brain monitoring having ten set leads 140, in accordance with one embodiment of the invention. The set leads are colour coded and of particular lengths to enable appropriate positioning of electrodes to areas Fp1, Fp2, T3, T4 C3, C4, O1, O2, GND and REF that are well known in the art for monitoring brain activity.

### Example 4

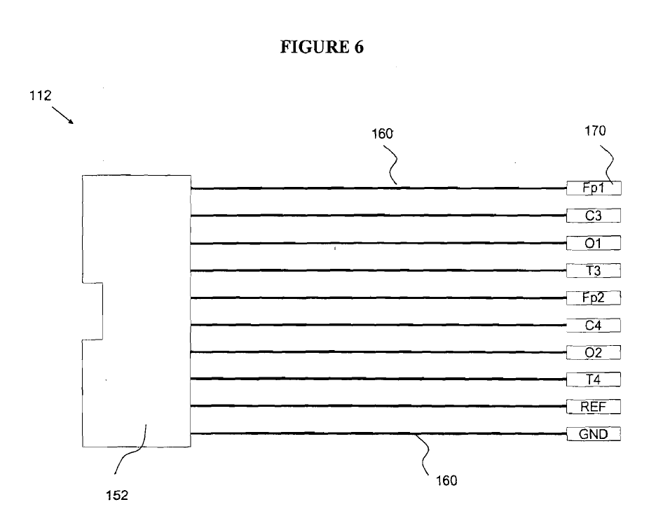

FIG. 6 illustrates a lead link, in accordance with one embodiment of the invention. In this embodiment, the physiological monitoring device connectors 170 are labelled Fp1, Fp2, T3, T4 C3, C4, O1, O2, GND and REF corresponding to the placement of the electrodes on the scalp. The labelling may facilitate the coupling the set connector and link connector, as well as the coupling of the physiological monitoring device connectors to a physiological monitoring device.

### Example 5

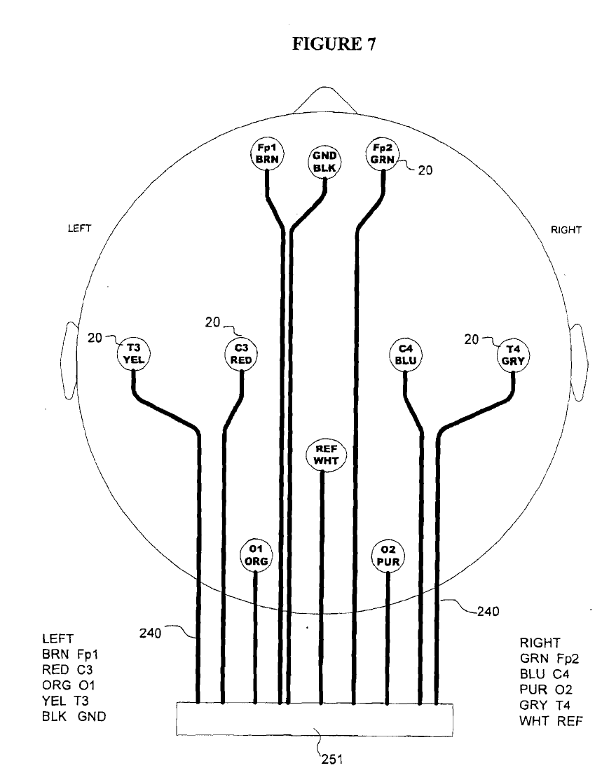

FIG. 7 illustrates an electrode set with ten set leads positioned on a patient's scalp for brain monitoring. In this embodiment, the set leads are colour codes, labelled and of particular lengths for appropriate positioning of electrodes to areas Fp1, Fp2, T3, T4 C3, C4, O1, O2, GND and REF that are well known in the art for monitoring brain activity. The length of the various leads should be about long enough to reach the specific target area on an average adult head without to much slack to provide an lead set that is compatible with MRI devices.

### Example 6

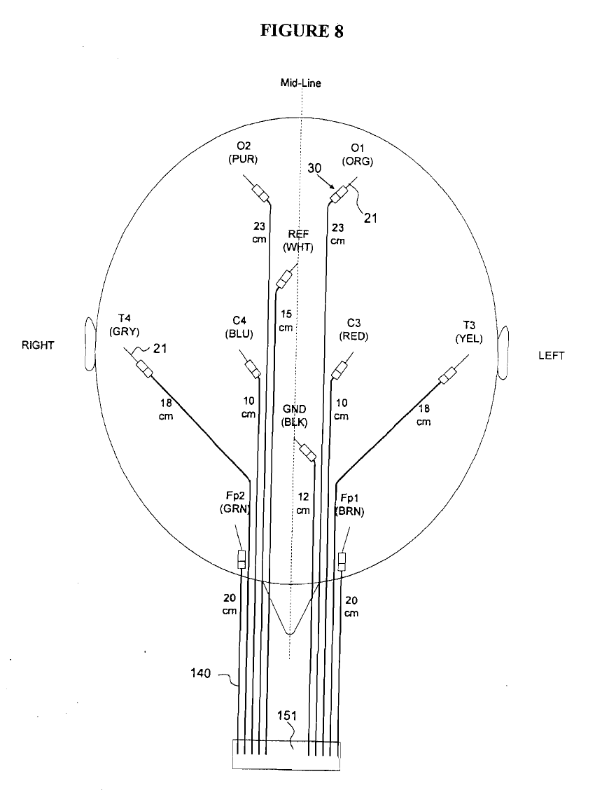

FIG. 8 illustrates a lead set with ten set leads coupled to subdermal wire electrodes positioned on a patient's scalp for brain monitoring. In this embodiment, the set leads 111 are colour coded, labelled and of particular lengths for appropriate positioning of electrodes to areas Fp1, Fp2, T3, T4 C3, C4, O1, O2, GND and REF that are well known in the art for monitoring brain activity. The length of the various leads should be about long enough to reach the specific target area on a average adult head without to much slack to provide an lead set that is compatible with MRI devices.

### Example 7

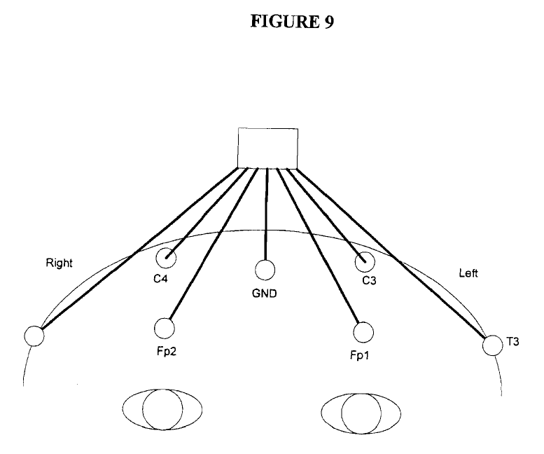

FIG. 9 illustrates a front view of an electrode set on a patient's head, in accordance with an embodiment of the invention. In this embodiment, the set leads are substantially long enough to reach the specific target area on an average adult head without providing a spider-like arrangement with the set connector in close proximity to the scalp.

### Example 8

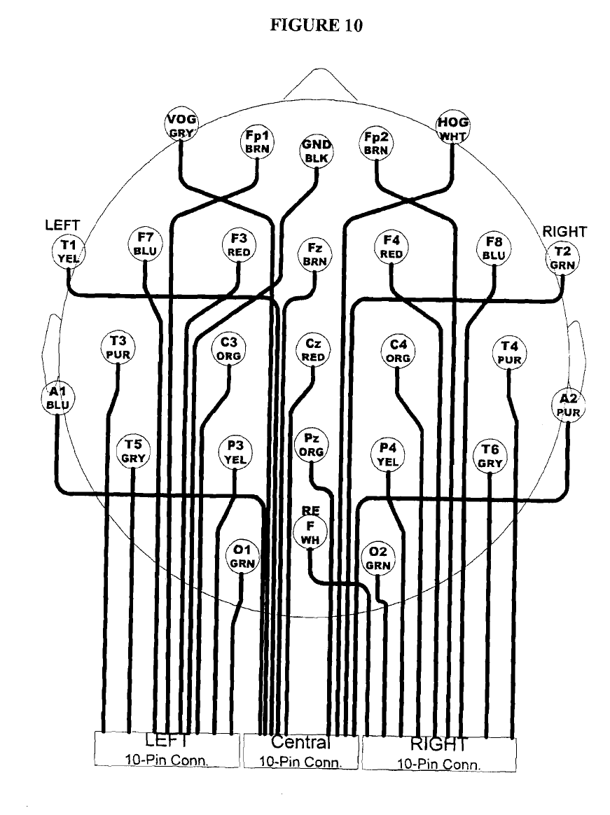

With reference to FIG. 10, there is provided a diagram of a lead assembly or electrode system for twenty-seven electrodes, in accordance with an embodiment of the invention. In this embodiment, each lead assembly or electrode system has nine leads coupled to a lead connector. The set leads are colour coded, labelled and of particular lengths for appropriate positioning of electrodes to areas that are well known in the art for monitoring brain activity. The three lead connectors may either be coupled to three lead links or to a single lead link connector. In another embodiment, the twenty seven electrodes are coupled to a single set connector.

### Example 9

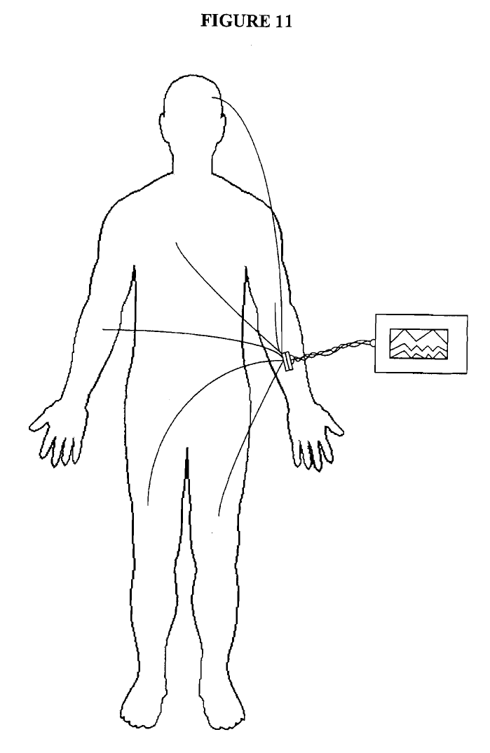

With reference to FIG. 11, there is provided a diagram of an electrode system or lead assembly positioned on a patient's body, in accordance with an embodiment of the invention.

### Example 10

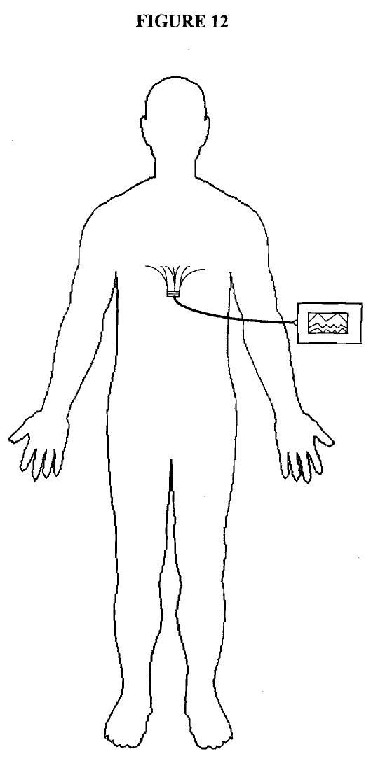

With reference to FIG. 12, there is provided a diagram of an electrode system or lead assembly positioned on a patient's arm, in accordance with an embodiment of the invention.

### Example 11

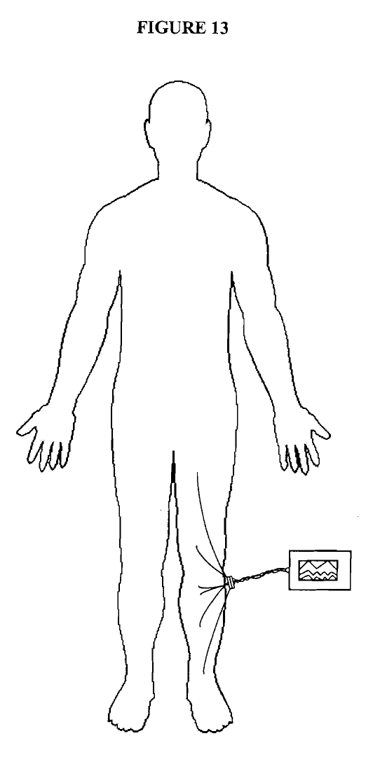

With reference to FIG. 13, there is provided a diagram of an electrode system or lead assembly positioned on a patient's leg, in accordance with an embodiment of the invention.

### Example 12

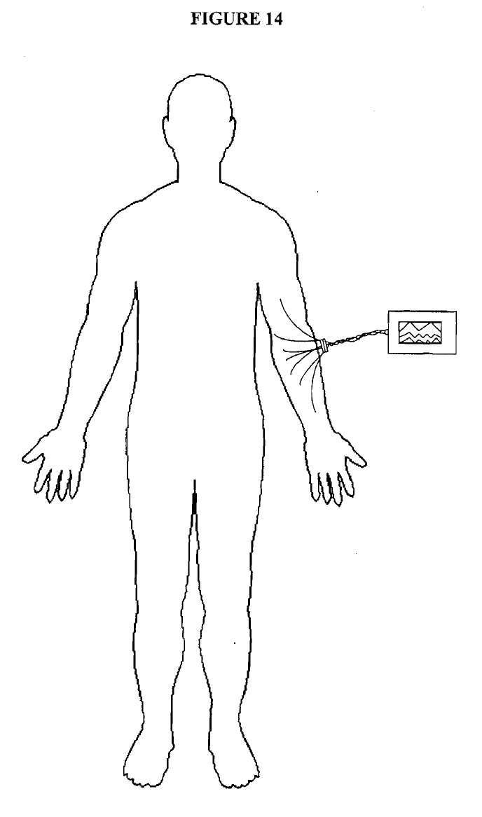

With reference to FIG. 14, there is provided a diagram of an electrode system or lead assembly positioned on a patient's chest, in accordance with an embodiment of the invention.

### Example 13

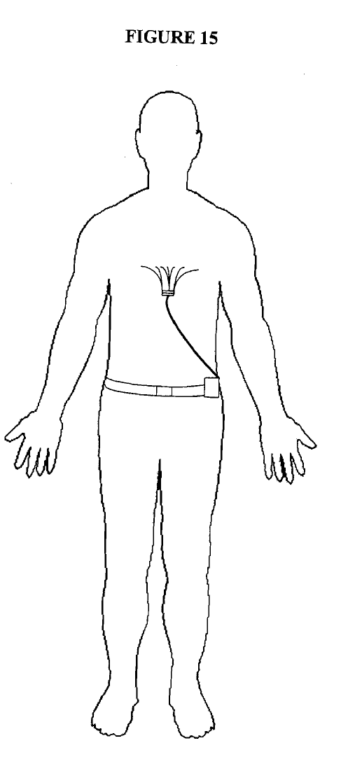

With reference to FIG. 15, there is provided a diagram of an electrode system or lead assembly for use with a portable recording device positioned on a patient's chest, in accordance with an embodiment of the invention.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. A lead assembly for linking one or more electrodes to a physiological monitoring device, the lead assembly comprising:
a lead set comprising a set connector and one or more set leads operatively coupled thereto, each one of which adapted for operative coupling to a respective one of the one or more electrodes; and
a lead link comprising a link connector and one or more link leads operatively coupled thereto, each one of which adapted for operative coupling to the monitoring device;
wherein each one of said one or more set leads corresponds to a respective one of said one or more link leads and is operatively coupleable thereto via operative coupling of said link connector and said set connector.

2. The lead assembly as claimed in claim 1, wherein said one or more link leads further comprise one of a common device connector and respective device connectors for operatively coupling same to the monitoring device.

3. The lead assembly as claimed in claim 1, wherein each of said set leads further comprises an electrode connector for operatively coupling same to said respective one of the one or more electrodes.

4. The lead assembly as claimed in claim 1, wherein the one or more electrodes are selected from the group consisting of subdermal wire electrodes, gold disc cup electrodes and conductive plastic electrodes cup coated with conductive silver-epoxy.

5. The lead assembly as claimed in claim 1 for linking a plurality of electrodes, wherein the lead assembly comprises a plurality of set leads, one or more of which being of a different length than that of one or more others.

6. The lead assembly as claimed in claim 5, wherein said different length comprises a predetermined length selected to substantially correspond with an average dimensional electrode configuration for a given type of physiological monitoring.

7. The lead assembly as claimed in claim 6, wherein said predetermined length is selected to provide an indication as to predetermined electrode placement locations on a patient for said given type of physiological monitoring.

8. The lead assembly as claimed in claim 7, wherein said predetermined electrode placement locations is consistent with International 10-20 System specifications.

9. The lead assembly as claimed in claim 1, the physiological monitoring being selected from the group consisting of ECG, EEG, EIT, EMG and EOG.

10. The lead assembly as claimed in claim 1, wherein each of said set leads are coded to substantially identify where said respective electrode should be attached.

11. The lead assembly as claimed in claim 1, wherein said lead link comprises a wire harness.

12. The lead assembly as claimed in claim 1, wherein said link connector and said set connector are operatively coupleable via a mated connection.

13. An electrode system for use with a physiological monitoring device, the system comprising:
one or more electrodes;
a lead set comprising a set connector and one or more set leads operatively coupled thereto, each one of which operatively coupled to a respective one of said one or more electrodes;
a lead link comprising a link connector and one or more link leads operatively coupled thereto, each one of which adapted for operative coupling to the monitoring device;
wherein each one of said one or more set leads corresponds to a respective one of said one or more link leads and is operatively coupleable thereto via operative coupling of said link connector and said set connector.

14. The lead system as claimed in claim 13, wherein said one or more electrodes are selected from the group consisting of subdermal wire electrodes, gold disc cup electrodes and conductive plastic electrodes cup coated with conductive silver-epoxy.

15. The lead system as claimed in claim 13 for linking a plurality of electrodes, wherein the lead system comprises a plurality of set leads, one or more of which being of a different length than that of one or more others.

16. The lead system as claimed in claim 15, wherein said different length comprises a predetermined length selected to substantially correspond with an average dimensional electrode configuration for a given type of physiological monitoring.

17. The lead system as claimed in claim 16, wherein said predetermined length is selected to provide an indication as to predetermined electrode placement locations on a patient for said given type of physiological monitoring.

18. The lead system as claimed in claim 17, wherein said predetermined electrode placement locations is consistent with International 10-20 System specifications.

19. The lead system as claimed in claim 13, the physiological monitoring being selected from the group consisting of ECG, EEG, EIT, EMG and EOG.

20. A lead set for linking multiple electrodes to a physiological monitoring device via an intermediary link, the lead set comprising:
multiple leads each adapted for operative coupling to a respective one the multiple electrodes; and
a connector adapted for connection to the intermediary link;
wherein each of said leads is operatively coupled to said connector and operatively coupleable to the monitoring device via connection of said connector to the intermediary link.

21. The lead set as claimed in claim 20, wherein one or more of said leads are of a different length than that of one or more others.

22. The lead set as claimed in claim 21, wherein said different length comprises a predetermined length selected to substantially correspond with an average dimensional electrode configuration for a given type of physiological monitoring.

23. The lead set as claimed in claim 22, wherein said predetermined length is selected to provide an indication as to predetermined electrode placement locations on a patient for said given type of physiological monitoring.

24. The lead set as claimed in claim 23, wherein said predetermined electrode placement locations is consistent with International 10-20 System specifications.

25. The lead set as claimed in claim 21, wherein said given type of physiological monitoring is based on at least one of a patient body part, a patient type, a patient size, and a patient condition to be monitored.
